(19) United States
(12) Patent Application Publication
(10) Pub. No.: US 2013/0035949 A1
(43) Pub. Date: Feb. 7, 2013

(54) Integrated wellness index and method of measuring overall wellness and treatment

(71) Applicant: Stephen J. Saltzman, Annapolis, MD (US)

(72) Inventor: Stephen J. Saltzman, Annapolis, MD (US)

(21) Appl. No.: 13/507,805

(22) Filed: Jul. 30, 2012

Related U.S. Application Data
(60) Provisional application No. 61/574,415, filed on Aug. 2, 2011.

(51) Int. Cl. G09B 23/28; G06Q 50/22

(52) U.S. Cl. 705/2; 434/262

(57) ABSTRACT

A tool and method of diagnosis and treatment of a patient by employing an integrated wellness index to achieve maximum health and to determine the underlying causes of disease states. A wellness index assigns a point system for essential health factors to measure various health parameters and overall health of a patient and assist the tracking of a patient's health status over time.

This application claims priority of U.S. Provisional Ser. No. 61/574,415 filed Aug. 2, 2011 incorporated herein in its entirety.

### BACKGROUND OF THE INVENTION

1. Field of the Invention

This invention relates to diagnosis and treatment of a patient by employing an integrated wellness index to achieve maximum health and to determine the underlying causes of disease states. The wellness index assigns a point system for essential health factors to measure overall health of a patient and assist the tracking of a patient's health status over time.

2. Brief Description of Related Art

Modern medicine is invested in costly surgical procedures and high priced pharmaceuticals rather than on natural solutions. Limited research funding is available for alternative therapies and it is the research funding that determines a medical school's curriculum as well as physician practice standards. Medical sub-specialization results in patients seeing specialists such as internists, cardiologists, nephrologists, etc., each of which concentrates on an individual organ system but rarely considers the individual as an integrated, whole entity. What is deficient in medicine is a standard integrated system of measuring overall health, diagnosing, and treating a patient to achieve maximum wellness and longevity. What is also deficient is a method of tracking health factors in a patient or population over a period of time. A population is defined as two or more people of a defined geographic location, ethnic group, religion or family.

### SUMMARY OF THE INVENTION

A method of measuring wellness in a person relative to an wellness index wherein a wellness index is created having maximum possible points assigned for at least two wellness factors; point scores are measured for the same at least two wellness factors in a patient; the point scores are compared from the patients wellness factors to the wellness index maximum possible points; and wellness of the patient is determined by examining how close the patient is to the maximum possible points in the index.

### BRIEF DESCRIPTION OF THE FIGURES

FIG. 1 is a schematic model of the wellness index showing the interrelationship of wellness factors; and

FIG. 2 is a schematic model of disease progression.

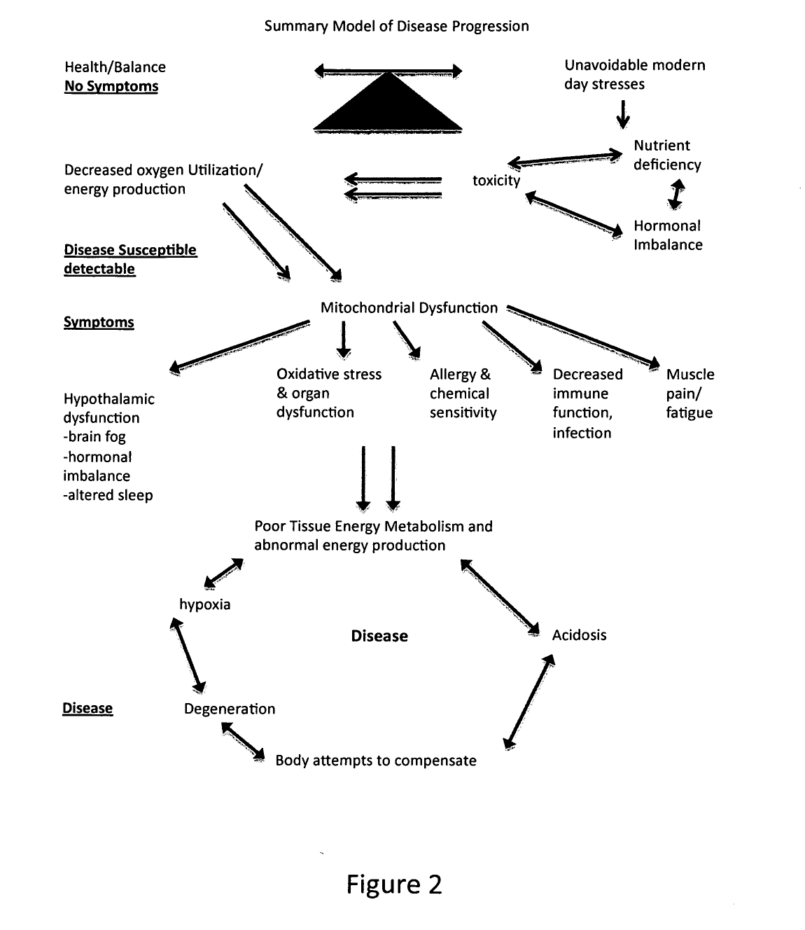

### DETAILED DESCRIPTION

Optimum health consists of balanced hormones, replenishment of nutritional deficiencies, elimination of toxins, and maximization of oxygen utilization. Wellness is defined as overall body tissues in a healthy growth and repair state rather than in an unhealthy degeneration state.

The present invention provides a focused approach on the underlying causes of disease states. This approach incorporates the use of important determinants of disease and accelerated aging and offers potential solutions. The invention is an integrated wellness model that is preferably based on major aspects or pillars that must be in balance for an individual to experience maximum health. Each pillar affects the other pillars and hence, overall health.

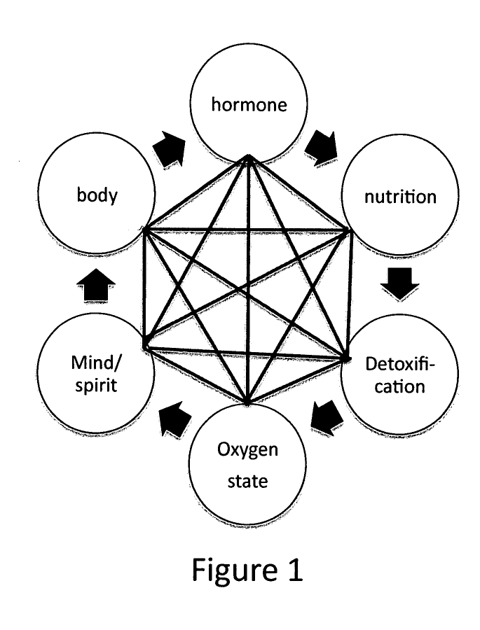

As shown in FIG. 1, the preferred six pillars are 1) hormone restoration, 2) nutrition, 3) detoxification, 4) oxygen & oxidative therapies, 5) mind/spirit, and 6) body. FIG. 1 is a schematic model showing how all of the pillars are interrelated and relate to anti-aging, longevity and vitality in an individual patient. Other pillars can be added to the wellness index and be scored. Pillars are defined as health factors affecting the human body.

At least two pillars must be incorporated in the wellness index. Each pillar is assigned a maximum score. Maximum score is defined as the highest score in a pillar that a person in perfect health could receive. For purposes of example only, this description mentions six pillars and assigns each of the six pillars a point score, wherein a maximum score for all pillars is 1000.

It is possible that as few as two pillars could be used wherein the point score for the assigned two pillars is adjusted so that a total for the two pillars is 1000 points for a person in perfect health. Three, four, five, etc. pillars could be used where in the total score for each scenario would equal 1000. The total of 1000 is used as a convenient total for the index, however, a different total score number for perfect health could be used without departing from the spirit of the invention.

In the invention, each pillar it tested and assigned a point score. The point score for all of the pillars in added up at the end of testing to provide an overall health score. The maximum score that a patient could receive is 1000 points. See Example 1 for scoring system for six pillars of health.

Patients are tested in each pillar to determine a baseline health score. Their score is compared to an index to see how the patient compares to a perfectly healthy person. Depending on the outcome of the scoring, various therapies are administered with the goal of elevating pillar scores and overall wellness index score. Patients may be retested at a later time to determine whether or not the patient's score has improved and to re-evaluate appropriate therapies. It is preferred to test all pillars and retest overtime to determine health state and change.

Each of the major pillars is described as follows: (See also Table 1 and Example 1)

### Pillar 1: Hormone Restoration

Hormones determine countless aspects of the body, including growth and development, metabolism, reproduction and wound healing. As a person ages, their hormones decline and with this decline comes susceptibility to disease states. Aging is defined as the progressive loss of physical and mental function over time. The process is inevitable but the extent of aging commonly seen today is not. Pillar 1 is hormone level and restoration because of the important role that hormone restoration plays over time. For example, estradiol, the major estrogen of pre-menopausal women, has over 400 effects in the body. As a woman enters menopause and her estradiol level falls, she becomes at an increased risk of cardiac disease, bone loss, and Alzheimer's dementia. It is not just estradiol levels that fall with age. Hormone imbalance begins in the 30's decade and progresses. By age 50, women are at a 50% of normal hormonal function for estrogen, progesterone, testosterone, DHEA, melatonin, and growth hormone, etc. This hormone state is termed menopause in women and andropause in men. Hormone restoration using natural “bio-identical” hormone therapies can prevent disease states.

Other hormones that are important include insulin for regulating blood sugar. Improper balance of insulin results in diabetes. Adrenal corticoid hormone is used to treat Addison's disease and growth hormone is used to treat dwarfism. Pillar 1 is an analysis of patient thyroid hormone, adrenal hormone, growth hormone, DHEA, estrogen and its metabolites, testosterone, vitamin D levels, insulin and other blood sugar measurements. There are patients that produce none of these hormones but there is also many patients that produce small but insufficient amounts of important hormones. The treatment involves optimization of hormonal function for a wide variety of hormones.

In the model of the invention, state of the art testing is employed to measure hormone levels in a variety of body fluids including blood, urine, and saliva as each has benefits and limitations allowing for different assessments. Standard urine analysis offers the sum of all of the metabolites of hormones, providing measures of catabolic (breakdown) and anabolic (building up) balance, as well as a ratio of the two. This is significant as it casts light on hormonal level to determine whether an individual is in growth and repair state or in tissue breakdown state. These states are fully hormone dependant. The wellness index of the invention places a significant valuation on this ratio, which is ideally a greater ratio.

Estrogen detail: More crucial information comes from testing for estrogen breakdown products and the body's capacity to transform dangerous compounds termed phase 1 and phase 2 detoxification pathways. Estrogen metabolites have different effects throughout the body. For example, 2-OH-estrone is safer than 16-OH-estrone and this ratio can be predictive of a risk of breast cancer. Chemical reactions, termed methylation reactions, allow for the transformation of potentially dangerous chemicals into more benign compounds that can be excreted from the body. This test also identifies crucial opportunity for intervention to improve health.

Specific hormones that can be tested and scored are: Glucocorticoids, androgens, progesterone, estrogens, testosterone, insulin.

Estrogen metabolites may also be tested such as: 2-Hydroxyestrone, 16α-Hydrowyestrone, 4-Hydrowyestrone, 2-Methoxyestrone, 4-Methoxyestrone.

Hormone ratios may also be tested such as: Anabolic/Catabolic Balance (17 Ketosteroids to 17 Hodroxysteroids ratio for estrogen metabolism index), 11-β-HSD Index, E/A: 5-β/5-α Ratio, 2-Hydroxyestrone/16α-Hydroxyestrone Ratio, 2-Methoxyestrone/2-Hydroxyestrone Ratio for methylation activity, 4-Methoxyestrone/4-Hydroxyestrone Ratio, Estriol Quotient E3/(E1-E2).

Additional Markers may also be tested such as Triiodothyrone, T3, Human Growth Hormone.

Hormone function can then be optimized using hormone therapy and more preferably using bio-identical hormones. These therapies are closely monitored on a regular basis for effectiveness and other effects.

Testing of hormones is shown in Example 1. The max score for hormone restoration in Example 1 is 200 points.

Pillar 2: Nutrition:

Pillar 2, nutrition, addresses all aspects of nutrition including not only what goes into a patient's body but also the processes that the food must undergo once internalized-digestion, absorption, and assimilation. These processes take energy and require enzyme, co-factors, and vitamins for optimal function. This pillar of wellness is crucial because soil is nutrient depleted; the vast majority of individuals consume a nutrient poor diet, and about 95% of all disease results from a combination of nutrient deficiency and toxicity states.

There is no single ideal diet for everyone and diet should vary based upon many factors such as age, phase of life, dietary goals, and specific training, seasons of the year, etc. Diet must be customized to each individual to provide for his or her nutritional needs. p Pillar 2 also includes intracellular nutritional analysis and comparison to normal controls. For purposes of evaluating nutrition, white blood cells are isolated and cultured by methods known in the art in several different mediums, each deficient in a single nutrient. Cells are then analyzed for the length of time that they can survive until they succumb secondary to the specific nutrient deficiency, and this survival period is compared to a large population of normal tests. This means that it can be determined that a person's B12 or folic acid or zinc intracellular level is 27% or 67% or 85% relative to a normal population, for example. The goal is to keep the individual's nutrient level in the upper quartile of normal, the 75-100% range. Such testing is known in the art, Spectrocell Laboratories, Inc. Houston, TX.

sNutrition Density and Unrefined Foods:

The nutritional testing also provides a direct measure of an individual's anti-oxidant capacity. This is determined by exposing some of the individual's isolated and cultured cells to radiation and measuring the ability of the DNA to withstand damage via radiation, a direct affect of the anti-oxidant capacity. It also includes serum testing. As stated previously, there is no single correct diet for all individuals, and that nutrient requirements change with a host of conditions: age, activity level, body composition goals (runner vs. weight lifter), climate, disease states, gestation, etc. For, example, the nutrient needs of a child undergoing rapid brain development differ from an athlete looking to increase lean muscle mass, and these differ further from an adult recovering from cancer, or a young woman interested in pre-conception planning.

Raw food or cultured food is food where none of the ingredients are exposed to a temperature greater than 116 degrees. Cultured foods are foods that have been partially pre-digested by beneficial species of bacteria. These two types of foods are beneficial because they tax the body's systems the least and offer the greatest degree of nutrition. This is because when in any heating process, nutrition is lost and more energy is expended to break the food down. For example, when protein is heated its structure is denatured and more energy is required to break it down to its component amino acids. Raw foods do not undergo this denaturing process and are more easily broken down and assimilated. Thus raw foods have greater protein utilization then cooked foods. Cooking also destroys enzymes, which are specialized proteins that increase the rate of chemical reactions in our bodies. Enzyme consumption is crucial for health and raw foods and cultured foods have a full complement of enzymes. Cooking via any means above 116 degrees leaves food devoid of all vital enzymes-- we can even introduce cancer causing chemicals via certain methods of cooking.

Cultured foods consist of naturally fermented vegetables such as sauerkraut, Kim chi, yogurt, raw milk cheese, and kefir. Cultured foods offer all of the benefits of raw foods plus a significant dose of enzymes. Health suffers when these vital foods are not a part of the diet. Modern food manufacturing that requires high temperature and high-pressure pasteurization removes all of these benefits referred to above.

### Gut Transit Time and Acid/Alkaline Tissues

Colon transit time is the time required for a meal to be fully processed and eliminated. It uses to be about 20-45 hours in the time of and the colon typically contained about three undigested meals at any time. Today, the numbers are astonishing: the average colon transit time is 65-100 hours and up to 8 undigested meals can be in the colon at any one time. Even the best of foods can be turned into metabolic poisons secondary to a prolonged colon transit time. Stress levels participate in this process as well. When the sympathetic (fight or flight) nervous system is activated blood flow is redirected away from the gut to allow the organism the ability to manage the more urgent crisis in the moment. This fact combined with our prolonged gut transit times allows fats to become rancid, carbohydrates to ferment, and proteins to putrefy. The result is acidosis, and represents one of the hallmarks of degeneration and disease progression.

There are three conditions that the inventor has found to particularly predispose individuals to chronic degenerative disease states. There is a link between nutrient deficiency, acidosis, and hypoxia (low levels of oxygen) and their interaction to predispose to degenerative diseases of all kinds from cancer to heart disease to diabetes, etc. The measurement of the amount of acid or base in a given solution is termed pH. The scale is logarithmic meaning that a pH of 3 is 10 times more acidic then a pH of 4. Neutral pH is 7.0, while greater than 7 is defined as alkaline pH and lower than 7 is defined as acid pH. Every body fluid, with the exception of urine and stomach acid, functions optimally at an alkaline pH. For example, normal or “ideal” blood pH is 7.4, and it is a medical emergency should the blood pH fall below 7.2 demonstrating just how crucial this alkaline state is for life. There are buffering systems throughout the body that function to maintain these safe limits of pH. It is a goal of the invention to balance nutrition to improve acidosis and hypoxia.

This matters because bodies must maintain the state of alkalinity from the nutrients in the foods that are consumed, and if not enough alkaline minerals are consumed, then the blood compartment will “steal” these minerals from other body tissues such as the bones, saliva, connective tissue, and muscle. Since it is a life threatening medical emergency if blood pH becomes acidic, the body will do anything that it can to steal these alkaline minerals from all other possible body stores. This is degeneration. That is why nutrient density and alkaline minerals are so crucial, and why refined foods and acid producing foods are so damaging.

Specific nutrients tested may include vitamins, amino acids, metabolites, fatty acids, mineral, carbohydrate metabolism and antioxidents.

Oxygen and its interaction with acidic and alkaline body fluids.

Oxygen is the body's most important element. The body cannot survive without it and loss brain function occurs in 4-6 minutes without oxygen. Each cell behaves fundamentally different in the presence or absence of adequate oxygen levels. An alkaline solution can bind 100 more times the amount of oxygen than an acidic solution. So, as body tissues and cells become more acidic, oxygen is driven out of the cells. Nutrient deficiency leads to acidosis and a lowering of the pH of the body's fluids, the blood compartment takes precedence and steals alkaline minerals from other body tissues, which leads to degeneration, the degeneration is enhanced and accelerated by acidosis which drives oxygen out of the cells, worsening the vicious cycle and creating more degeneration. This causes disease proneness.

It has been shown that cancer thrives in anaerobic conditions, meaning oxygen deficiency resulting in acidosis in the cells. This also applies to heart disease, diabetes, arthritis, as all represent states of degeneration, tissue acidosis, and lack of oxygen (hypoxia). Alkaline producing foods include most vegetables and fruits, sprouted nuts and seeds, most spices and seasonings, while acidic producing foods include most meats and dairy products, and most commercially prepared grain products. Eating more oxygen binding foods will improve oxygen binding and improve degenerative disease.

### Elimination Diets, Food Allergies, Gluten Sensitivity

The top five food allergens include wheat, corn, milk, soy and peanut. An autoimmune disease is a disease in which the body attacks its own tissues. This may lead to disease, destruction, and death. More than 40 autoimmune conditions have been identified, including type 1 diabetes, rheumatoid arthritis and celiac disease. Together they constitute the third leading cause of sickness and death after heart disease and cancer and result from a triad of conditions that include genetic predisposition, immune deregulation, and environmental trigger. Further, all autoimmune conditions involve some degree of gut pathology: digestion/absorption, intestinal permeability, dysbiosis, and or inflammation. Therefore food allergy testing and gut pathology are an important assessment tool prior to any formal individual dietary recommendations.

### Low Animal Protein

A plant-based diet is the only diet that has been shown to play a role in disease reversal for heart disease and improvements in insulin sensitivity. Diets low in meat are prescribed. Therefore rather than promote any single diet for everyone, the dietary recommendations of the invention are customized to each individual and based on many important factors: including activity level, specific dietary goals and principles of nutrient density, low animal protein, unrefined carbohydrates, raw foods, low allergenic, anti-inflammatory, and high fiber content.

Remedies include nutrient dense foods, high concentration of fresh fruits and vegetables, limited animal protein, healthy fats, raw foods, cultured foods, sprouted nuts and seeds and avoidance or limiting of the major allergenic foods like wheat, corn, soy, milk and peanuts. Other remedies include Intravenous Nutritional Replacement Therapies.

Since diet alone may be inadequate to fully provide the entire complement of nutrition needed for optimal health and oral replacement therapies often have low absorption rates, the intravenous route of administration is employed in some cases. Anything administered intravenously is absorbed right into the blood stream as no dependency of stomach, liver, gallbladder or intestinal function is required. Much higher levels of nutrients by this route of administration are generated. This becomes an even more important mechanism of replacement in clients who have intestinal and or stomach conditions that impair specific nutrient absorption abilities. Lastly, intravenous replacement therapies also permit the ability to administer therapies that can boost the body's immune system or replacement fluid and nutrient requirements in patients not able to consume food by mouth.

Testing for nutrition in this example has a max score of 200 points. It involves intracellular nutritional analysis, anti-oxidant function, inflammation and pre-diabetes testing. (See Example 1)

### Pillar 3 Detoxification:

Each individual possesses a detoxification system. Its level of function determines the presence or absence of disease in every other system of the body. There are over 70,000 chemicals in existence today with 1000 new synthetic chemicals introduced yearly. Because so much carcinogenic and endocrine-disrupting plastics are ingested, there is a documented “average human daily intake.” Many of these toxins have no way to exit the body. They build up in the body and accumulate over the years producing chronic diseases of all kinds. Some examples of toxins are PCB's styrene, dioxins, gasses, and pesticides. These chemicals damage the reproductive system, immune system and/or nervous system.

Detoxification treatments:

1) Energy and nutrients

2) Oxygen delivered from hyperbaric chambers to deliver oxygen. Hyperbaric Oxygen Therapy (HBOT) is an incredibly powerful and proven medical therapeutic technique capable of treating medical disease states as well as serving as a preventative “wellness” tool. HBOT utilizes the principle of increasing the atmospheric pressure to allow not only the blood, but also all of the body's tissues, including plasma, lymphatic fluid, and cerebrospinal fluids, to all absorb additional oxygen. This “extra” or “additional” oxygen now is available to promote healing, to aid detoxification, to fight infection, and to help meet the body's need to achieve a state of optimal wellness or homeostasis--a balance of all of the body's many tasks and processes.

3) Far Infrared Saunas to mobilize toxins into sweat from fat stored under the skin. These saunas also briefly increase the body's temperature which improves the immune system health by boosting production of infection-fighting white blood cells and killer T-cells. It may also be effective for cardiovascular conditioning. As the body heats up, it cools itself by sending blood from the internal organs to the extremities and the skin, thus increasing heart rate, blood circulation, cardiac output and metabolic rate. Far Infrared saunas help reduce physical stress by boosting circulation and triggering the production of endorphins. Toxins can play a significant role in both causing weight gain and preventing weight loss. The cardiovascular effect from a single sauna 30 minute session burns as many as 600 calories.

### 4) Ozone Steam Therapy

Ozone is an activated and charged form of oxygen. Ozone occurs both naturally as lightening and ocean mist and can also be generated from an oxygen concentrator. The pleasant smell after a rainstorm is from ozone. Ozone can rapidly oxidize waste products, pollution, and microbes. Ozone is routinely used to sterilize municipal drinking water and most bottled waters.

Steam Therapy is known to:
Dramatically increase oxygenation of the tissues and cells Increase the White Blood Cell count
Increase circulation, oxygen and nutrient delivery within the body
Burn 400-600 calories per session!
Increase tumor necrosis factor by up to 500 times
Purge the body of accumulated toxins such as pesticides, PCBs, drug residues, acidic wastes and much more
Stimulate the Immune System
Kill bacteria and viruses
Relax and loosen sore muscles

Combining the use of steam with ozone therapy is a very powerful technique for healing. An ozone steam sauna is a device that encloses an individual's entire body except the head. Steam and ozone are then introduced into the cabin. As the steam dilates the pores, ozone enters, and the combination is a powerful detoxification experience.

Colon Hydrotherapy involves the use of warm water placed into the rectum via a catheter to help wash out and remove this toxic residue in the colon. It is painless and effective and beneficial for removing undigested material from the colon that the body cannot eliminate.

Toxicity testing and analysis. The invention incorporates laboratory testing to assess phase 1 and phase 2 steps of our client's detoxification systems. Individuals may have a 500-fold difference in their ability to detoxify a given chemical.

Oxygen detox profile involves hepatic detox profile, evidence of net retention of heavy metals and evidence of gut dysbiosis. Oxygen detox profile can measure D

Glucaric Acid and Mercapturic acids. Net retention of heavy metals can measure amounts of Aluminum, Antimony, Arsenic, Barium, Beryllium, Bismuth, Cadmium, Cesium, Gadolinium, Lead, Mercury, Nickel, Palladium, Platinum, Tellurium, Thallium, Thorium, Tin, Tungsten, Uranium and Creatinine. See Example 1.

Testing for the detoxification pillar has a max score of 150 points. See Example 1.

### Pillar 4: Oxygen and Oxidative Therapies

Oxygen is the most vital element to the human body. Healing of any kind cannot occur without oxygen delivery to the tissues. Ozone has powerful oxygenating and detoxifying powers. Pillar 4 is directed to the interrelationship of alkaline body tissues, nutrient density, and a surplus of oxygen at our cellular level. This is done by examining cellular energy production. This is crucial because optimal energy production actually dictates rate of aging and proneness to acquiring a disease state. One example of oxygen testing is Bio-energy Testing®. There are other known methods of testing oxygen delivery to the tissues such as a body oxygen test or CP (control pause) test.

Bio-Energy Testing® and Analysis

The deterioration and loss of function associated with aging is a very slow process. Long before symptoms first present, the cellular dysfunctions that result in optimal health and wellness are already established. Standard tests cannot measure these changes until after disease is established. Bio-Energy Testing® involves the use of a device connected to a computer that is able to measure how much oxygen the body uses and how much carbon dioxide the body is producing at a given time. A series of measurements are taken at rest and during a progressively more difficult exercise program. During these two phases, inhaled oxygen and exhaled CO₂ is measured. The Bio-Energy Testing® computer program then calculates resting mitochondrial efficiency, resting fat metabolism maximal mitochondrial efficiency, maximal fat metabolism. It can also determine optimum carbohydrate intake and optimum caloric intake.

The Bio-Energy Testing® used in this pillar is preferably measurement of C factor, fat burning factor, energy quotient, and biological index.

C-Factor indicates whether or not the patient's diet during the week immediately prior to the test contained the optimum ration of fat, carbohydrate, and protein.

Fat burning factor measures how the patient is able to convert fat to energy. The higher the fat burning factor, the more energy produced from fat.

Energy Quotient is a measurement of the maximum amount of energy a patient can produce aerobically, i.e. from oxygen. This is an important indicator of optimal mental and physical functioning and disease prevention.

Biological index is determined by a computer matching total energy dynamics of the patient with persons of the patient's sex, height and weight of various ages. The Bio-Energy Testing® analyzer is FDA approved. Bio-Energy Testing® was first introduced to the health care profession in 2004, and since then there are many Bio-Energy Testing centers throughout the US and around the world. It is a testing protocol that is well known in the medical community.

A max score for oxygen and oxidative therapy is 200.

In the Example of the invention, Bio-energy Testing® for the wellness index has a max score of 200 points. Broken down, the C factor measurement max score of 50 points, fat burning factor max score of 50 points, energy quotient max score of 50 points and biological index max score of 50 points.

A CP test is a controlled breathing and pause in breathing exercise wherein recovery ability after a pause in breathing is measured. If a CP test is used rather than a Bio-energy test®, a max score for a CP test is 200.

Therapies for this pillar include therapies that cause a brief and mild oxidative stress in the body that result in enhanced immune function, oxygenation benefits and other health benefits. These may involve the use of ozone as a treatment, hydrogen peroxide or ultra violet irradiation of blood.

### Pillar 5 Mind/Spirit

Optimal health is also dependant on mind and spirit state. Mind and spirit directly affects hormone levels and other body functions. To determine mind and spirit state in this pillar, a stress questionnaire is administered. (See Example 1).

Therapies for mind and spirit are spiritual practice, meditation and improvement in relationship practices.

The max test score is 125 points. The test is found in Example 1.

### Pillar 6 Body Muscle and Core Strength, Flexibility and Athletic Recovery

A series of tests are administered to a patient to determine muscle, core strength, flexibility and athletic recovery. A patient is asked to perform several positions and perform several exercises and is rated on ability to perform and length of time for performance. Examples of appropriate tests are defined in Example 1. A maximum point score for this pillar is 125 points. Other positions and exercises may be substituted as along as they are indicative of flexibility, muscle and core strength and athletic recovery.

TABLE 1
Wellness Index Scoring

| Pillar | Focus of Test | Max Score | Data Utilized |
|---|---|---|---|
| Pillar #1 | Anabolic vs. Catabolic | 50 points | Estrogens, estrogen metabilites, |
| Hormone | Balance | | progesterone, androgens, |
| Restoration | Hormone Balance | | glucocorticoids, human growth |
| | | | hormone, ratios |
| | | | Genova Complete Male or |
| | | | Female Urine Hormone |
| | | | Analysis. |
| | | | (Genova Diagnostics, Asheville, |
| | | | NC) |
| | Four point Salivary | 50 points | Genova Salivary Adrenal Cortex |
| | Cortisol Testing | | Stress Profile |
| | | | (Genova Diagnostics, Asheville, |
| | | | NC) |
| | Thyroid Testing | 50 points | Blood panel for T3, T4, TSH, |
| | | | RT3, Thyroid antibody profile, |
| | | | and clinical assessment of |
| | | | fatigue. |
| | Females: | 50 points | Genova Complete Urinary |
| | Estrogen, | | Hormones |
| | Progesterone, estrogen | | (Genova Diagnostics, Asheville, |
| | metabolization, | | NC) |
| | methylation | | |
| | Males: | 50 points | Free and Total Testosterone |
| | Testosterone | | Blood Test |
| | Estrogen | | |
| | metabolization, | | |
| | methylation | | |
| | Max Pillar #1 Total | 200 points | |
| Pillar #2 | Intracellular nutrition | 100 points | Spectracell Nutrition Analysis |
| Nutrition | analysis of B vitamins, | | (Spectracell Laboratories, Inc. |
| | amino acids, | | Houston, TX) |
| | metabolites, fatty | | See attachment 2a |
| | acids and other | | |
| | vitamins, minerals and | | |
| | carbohydrate | | |
| | metabolism | | |
| | Intracellular nutrition | 100 points | Spectracell nutrition analysis |
| | analysis - Anti- | | (Spectracell Laboratories, Inc. |
| | oxidant and Spectrox | | Houston, TX) |
| | sections | | |
| | Inflammation and Pre- | 50 points | Genova Diagnostics, Pre D |
| | diabetes test | | guide, blood test |
| | | | (Genova Diagnostics, Asheville, |
| | | | NC) |
| | Max Pillar #2 total | 200 points | |
| Pillar #3 | Phase 1 and Phase 2 | 50 points | Doctor's Data Hepatic Detox |
| Detoxification | detoxification | | Profile (Doctor's Data, Inc. St. |
| | | | Charles, IL) urine test |
| | Evidence of Heavy | 50 points | Doctor's Data Urine Toxic |
| | Metal Toxicity | | Metals (Doctor's Data, Inc. St. |
| | | | Charles, IL) urine test |
| | Evidence of Gut | 50 points | Doctor's Data comprehensive |
| | Dysbiosis | | Stool Analysis with Parasitology |
| | *Loss of 10 points if | | (Doctor's Data, Inc. St. Charles, |
| | evidence of either | | IL) |
| | dysbiotic yeast flora | | stool test |
| | or positive | | |
| | parisitology | | |
| | Max Pillar #3 Total | 150 points | |
| Pillar #4 | C Factor—a measure of | 50 points | Bio-Energy Testing ® |
| Oxygen and | carbohydrate intake | | (The Nevada Center of |
| Oxidative | and energy production | | Alternative and Anti-aging |
| Therapies | | | Medicine, Carson City NV) |
| | Fat Burning Factor—a | 50 points | Bio-Energy Testing ® |
| | measure of the body's | | (The Nevada Center of |
| | ability to convert fat | | Alternative and Anti-aging |
| | into energy | | Medicine, Carson City NV) |
| | Energy Quotient—maximum | 50 points | Bio-Energy Testing ® |
| | amount of energy produced | | (The Nevada Center of |
| | aerobically | | Alternative and Anti-aging |
| | | | Medicine, Carson City NV) |
| | Biological Index—a | 50 points | Bio-Energy Testing ® |
| | standardized measure | | (The Nevada Center of |
| | of the body's overall | | Alternative and Anti-aging |
| | efficiency to produce | | Medicine, Carson City NV) |
| | energy | | |
| | Max Pillar #4 Total | 200 points | |
| Pillar #5 | Stress Questionnaire | 125 points | See Example 1 |
| Mind/Spirit | Max Pillar #6 Total | 125 points | |
| Pillar #6 | Plank Position | 25 points | See Example 1 |
| Muscle, Core | Chin Up Position | 25 points | See Example 1 |
| Strength, | Push Up Position with | 25 points | See Example 1 |
| Flexibility & | balance requirements | | |
| Athletic | Wall Squats position | 25 points | See Example 1 |
| Recovery | Flexibility Exercise 1 | 15 points | See Example 1 |
| | Forward bending | | |
| | position | | |
| | Flexibility Exercise 2 | 10 points | See Example 1 |
| | Knee, ankle and foot | | |
| | stretch | | |
| | Max Pillar #7 Total | 125 | |

Having generally described this invention, a further understanding can be obtained by reference to certain specific examples, which are provided herein for purposes of illustration only and are not intended to be limiting unless otherwise specified.

### EXAMPLES

### Example 1

### Wellnes Index: Pillars Scoring System

### Pillar 1: Hormone Restoration

Hormone Restoration. Max Score 200 points
A. Anabolic vs. Catabolic Balance. Test utilized: Genova Complete male or female urinary hormone analysis, max score 50 points
   Ratio of 0.86-1.0 or higher, 50 points
   Ratio of .0.7-0.85, 40 points
   Ratio of 0.55-0.69, 30 points
   Ratio of 0.45-0.54, 20 points
   Below 0.53, zero points
B. Four point Salivary Testing. Test utilized: Genova Adrenal cortex Stress Profile, Salivary
   Normal Sum total and normal levels for all 4 points, 50 points
   One deficiency either sum or individual point, 35 points
   Two deficiencies either sum or individual points, 25 points
   Three of more deficiencies, zero points
C. Thyroid Testing. Blood panel for T3, T4, TSH, RT3, Thyroid antibody profile, and clinical assessment of fatigue. Max score 50 points.
   Free T3 and Free T4 in upper half of normal range with normal Antibody titer and no fatigue, 50 points
   Free T3 and Free T4 in upper half of normal range with normal Antibody titer and fatigue, 45 points
   Free T3 or Free T4 in lower half of normal range, or elevated Antibody titer and, 30 points
   All other combinations, zero points, see Reference ranges below:

| | | |
|---|---|---|
| TSH: 0.300-3.000 uIU/mL | Free T4: 0.71-1.85 ng/dL | Free T3: |
| | | 1.45-3.48 pg/mL |
| TPO-Ab: 0.00-12.0 IU/mL | TG Ab: 0.00-45 IU/mL | |

Estrogen and Progesterone in Women or Testosterone in Men. Testing utilized, Genova Complete Urinary Hormones, Max score 50 points.
Women: Estradiol and Progesterone level in mid-luteal phase range, with normal estrogen metabolization, and effective methylation, 50 points.
One of the following: Estradiol or Progesterone below mid-luteal range, abnormal estrogen metabolization, poor methylation, 40 points.
Two of the following: Estradiol or Progesterone below mid-luteal range, abnormal estrogen metabolization, poor methylation, 25 points.
Any other combinations, zero points.
Men: Total Testosterone level no less than 20 points below the client's given age reference (see below) with normal estrogen metabolization and effective methylation, 50 points.
Total Testosterone level no less than 40 points below the client's given age reference (see below) normal estrogen metabolization, normal methylation, 40 points.
Total Testosterone level no less than 60 points below the client's given age reference (see below), either abnormal estrogen metabolization, or poor methylation, 30 points.
Any other combination, zero points.
Average Testosterone Levels by Age in Men

Androgen levels with age₁
Measurements in Conventional Units (ng/dl), SHBG in (nmol/L)

| | Total | Free |
|---|---|---|
| Age | Test | Test |
| 25-34 | 617 | 12.3 |
| 35-44 | 668 | 10.3 |
| 45-54 | 606 | 9.1 |
| 55-64 | 562 | 8.3 |
| 65-74 | 524 | 6.9 |
| 75-84 | 471 | 6.0 |
| 85-100 | 376 | 5.4 |

### PILLAR 2: NUTRITION

Nutrition. Max Score 200 points.
a. Intracellular nutritional analysis. Test Spectracell Intracellular Nutrient Analysis. Test consist of all intracellular nutrient levels except Antioxidants (B vitamins, amino acids, metabolites, fatty acids, and other vitamins, minerals and carbohydrate metabolism), Max score 100 points.
Two or less deficiencies and all three are not more than 7 percentage points below the reference range, 100 points, if more than 7 percentage points below the reference range, −5 points per occurrence
Between three to five deficiencies, 80 points, if more than 7 percentage points below the reference range, −5 points per occurrence
Between six and eight deficiencies, 65 points, if more than 7 percentage points below the reference range, −5 points per occurrence
Above nine deficiencies, 0 points
b. Anti-Oxidant Function. Test Spectracell Intracellular Nutrients. Data consists of Anti-oxidant and Spectrox sections only. Max score, 50 points.
If no deficiencies in either category, 50 points
If one deficiency, 45 points, if deficiency is more than 7 percentage points below the reference range, −5 points
If two deficiencies, 40 points, if deficiency is more than 7 percentage points below the reference range, −5 points per occurrence
If three deficiencies, 30 points, if deficiency is more than 7 percentage points below the reference range, −5 points per occurrence
If four or more, 0 points
c. Inflammation and Pre-Diabetes Test. Genova Diagnostics, Pre D guide. Max score,
50 points combined.
Normal Pre Diabetes Test, 30 points
Stage 1 Pre-Diabetes Test, 20 points
Stage 2 Pre Diabetes Test, 10 points
Stage 3 Pre Diabetes Test, 0 points
Average Inflammation Score of 1.0-1.5, 20 points
Average Inflammation Score of 1.51-2.0, 10 points
Average Inflammation Score greater than 2.0, 0 points
   PILLAR 3: DETOXIFICATION Max score 150 points.

a. Hepatic Detox Profile, Doctors Data, Max score 50 points
If both D-Glucaric acid and Murcapturic acid results are in the percentile range of 16-50, then 50 points
If both D-Glucaric acid and Murcapturic acid results are in the percentile ranges of 51-84, then 40 points
If D-Glucaric acid is below the percentile range of 50 and Murcapturic acid results are in the percentile range greater then 84, 30 points
If D-Glucaric acid is below the percentile range of 50 and Murcapturic acid results are in the percentile range greater then 85, 0 points
b. Evidence of Net Retention of Heavy Metals, Doctors Data Urine Heavy Metal Test, Max score, 50 points
Only 1 or 2 metals in the “reference range”, 50 points
Only 1-2 metals in the “elevated” range, 40 points
Three to four metals in the reference range, 25 points
Anything else, 0 points
c. Evidence of Gut Dysbiosis, Comprehensive Stool Analysis with Parasitology, Doctors Data, Max score 50 points
Five species present of normal flora at a level of at least 2+ with no evidence of dysbiotic flora, 50 points
Four species present of normal flora at a level of at least 2+ with no evidence of dysbiotic flora, 40 points
Four species present of normal flora with one or more at a level below 2+ and evidence of dysbiotic flora at level below 2+, 30 points
Four species present of normal flora with one or more at a level below 2+ and evidence of dysbiotic flora at level above 2+, 20 points
Yeast culture result with presence of dysbiotic flora, -10 points
Parasitology Report positive, −10 points

### PILLARS 4 Oxygen and Oxidative Assessment, Basic Energy Testing,

Max Score of 200 points
A. C Factor, a measure of carbohydrate intake and energy production, 50 points
   C Factor 100 or higher, 50 points
   C Factor between 80-99, 40 points
   C Factor between 70-79, 30 points
   C Factor between 60-69, 20 points
   Below 60, 0 points
B. Fat Burning Factor, a measure of the body's ability to convert fat into energy
   Fat Burning Factor above 100, 50 points
   Fat Burning Factor between 80-99, 40 points
   Fat Burning Factor between 70-79, 30 points
   Fat Burning Factor between 60-69, 20 points
   Below 60, 0 points
C. Energy Quotient, maximum amount of energy produced
   Energy Quotient above 100, 50 points
   Energy Quotient between 80-99, 40 points
   Energy Quotient between 70-79, 30 points
   Energy Quotient between 60-69, 20 points
   Energy Quotient below 60, 0 points
D. Biological Index, a standardized measure of the body's overall efficiency to produce energy
   Biological Index above 100, 50 points
   Biological Index between 80-99, 40 points
   Biological index between 70-79, 30 points
   Biological Index between 60-69, 20 points
   Biological Index below 60, 0 points
      PILLAR 5: MIND AND SPIRIT Max Score of 125 points

### Stress Questionnaire

A patient is asked to answer the following questionnaire by circling the number that is most accurate for each condition. Answers are to be based on occurrences over the past twelve months.

| 1. Mental/Emotional Stress Event | Never | Rarely | Occasional | Often |
|---|---|---|---|---|
| I feel angry | 0 | 5 | 10 | 15 |
| I feel worried | 0 | 5 | 10 | 15 |
| I feel fearful | 0 | 5 | 10 | 15 |
| I spend time in a state of grief | 0 | 5 | 10 | 15 |
| I feel hopelessness | 0 | 5 | 10 | 15 |
| I have feelings of guilt | 0 | 5 | 10 | 15 |
| I feel depressed | 0 | 5 | 10 | 15 |
| I feel anxious | 0 | 5 | 10 | 15 |
| I feel irritable | 0 | 5 | 10 | 15 |
| I feel fatigued | 0 | 10 | 15 | 20 |
| I have indigestion | 0 | 10 | 15 | 20 |
| I have muscle tightness/tension | 0 | 10 | 15 | 20 |
| I grind my teeth | 0 | 10 | 15 | 20 |
| I have decreased interest in sex | 0 | 10 | 15 | 20 |
| I feel faint or dizzy | 0 | 10 | 15 | 20 |
| I am concerned about money | 0 | 20 | 25 | 30 |
| I am unhappy at my job | 0 | 25 | 30 | 35 |
| I am concerned about my job stability | 0 | 25 | 30 | 35 |
| I am worried about the economy | 0 | 30 | 35 | 40 |
| My work performance has declined | 0 | 30 | 35 | 40 |
| Mental/Emotional Stress Event | No | Yes | | |
| There has been a change in my living conditions | 0 | 35 | | |
| I recently lost a close friend | 0 | 40 | | |
| I recently retired | 0 | 45 | | |
| I lost my job | 0 | 50 | | |
| I have significant financial problems | 0 | 50 | | |
| I suffered a personal injury | 0 | 50 | | |
| A family member of mine recently died | 0 | 55 | | |
| I am in trouble with the law | 0 | 60 | | |
| I am getting a divorce | 0 | 65 | | |
| Close relative with drug/alcohol problem | 0 | 70 | | |
| My spouse recently passed away | 0 | 75 | | |
| 2. Metabolic Abnormalities | Never | Rarely | Occasional | Often |
| I often skip meals | 0 | 25 | 30 | 35 |
| I practice significant calorie restriction | 0 | 30 | 35 | 40 |
| I crave carbohydrates | 0 | 30 | 35 | 40 |
| I consume alcohol in excess | 0 | 35 | 40 | 45 |
| I smoke | 0 | 35 | 40 | 45 |
| I consume refined foods | 0 | 35 | 40 | 45 |
| My stomach is upset | 0 | 35 | 40 | 45 |
| I have had recent changes in my appetite | 0 | 35 | 40 | 45 |
| 3. Inflammation/Tissue Damage/Pain | No | Yes | | |
| I recently underwent surgery | 0 | 30 | | |
| I recently suffered a trauma or injury | 0 | 30 | | |
| I have chronic infections | 0 | 35 | | |
| I have multiple allergies | 0 | 40 | | |
| I have multiple food sensitivities | 0 | 40 | | |
| I have Crohn's Disease or Ulcerative Colitis | 0 | 40 | | |
| I am sensitive to wheat | 0 | 40 | | |
| I have arthritis or joint pain | 0 | 40 | | |
| I am sensitive to mold and/or other toxins | 0 | 40 | | |
| 4. Stress from Extreme Conditions | Never | Rarely | Occasional | Often |
| I am exposed to extremes of temperature | 0 | 30 | 35 | 40 |
| I am often sleep deprived | 0 | 35 | 40 | 45 |
| I exercise excessively | 0 | 35 | 40 | 45 |
| I am often ill | 0 | 40 | 45 | 50 |
| I am sensitive to electromagnetic fields | 0 | 40 | 45 | 50 |
| I have an altered sleep/wake cycle | 0 | 45 | 50 | 55 |
| I work in a high noise environment | 0 | 45 | 50 | 55 |
| I crave caffeine or other addictive drugs | 0 | 45 | 50 | 55 |
| Excessive use of TV, computer, or video | 0 | 45 | 50 | 55 |
| games | | | | |
| 5. Effective Stress Management Tools | Never | Rarely | Occasional | Often |
| I have a plan for managing my stress | 0 | 35 | 40 | 45 |
| I eat organic and use healthy body care | 0 | 35 | 40 | 45 |
| products | | | | |
| I enjoy listening to music | 0 | 35 | 40 | 45 |
| I make time for regular exercise | 0 | 35 | 40 | 45 |
| Spending time with friends/family is a priority | 0 | 35 | 40 | 45 |
| I pray | 0 | 35 | 40 | 45 |
| I have hobbies that I enjoy | 0 | 35 | 40 | 45 |
| I enjoy and practice a religion/spiritual beliefs | 0 | 35 | 40 | 45 |
| My pet(s) help me relax | 0 | 35 | 40 | 45 |
| I enjoy playing sports | 0 | 35 | 40 | 45 |
| I practice yoga and/or meditation | 0 | 35 | 40 | 45 |
| I benefit from psychotherapy | 0 | 35 | 40 | 45 |

Scoring for Stress questionnaire: Add up all points for categories 1-4. Subtract section 5 from the sum of categories 1-4 for a final score.

| | | |
|---|---|---|
| 0-150, | 125 | points |
| 151-250 | 100 | points |
| 251-350 | 75 | points |
| 351-450 | 50 | points |
| 451-550 | 25 | points |
| above 551 | zero | points |

Pillar 6: Assessment of Muscle and Core Strength, Flexibility, and Athletic Recovery Maximum point value is 125 points.

After appropriate warm-up, patients perform the following five activities. Patients may make multiple attempts utilizing up to 5 minutes for each exercise:
1. Plank position (defined as forearms on the ground, toes on the ground, rest of body stabilized off the ground), assessing Core Muscle Strength. Max Score for this Exercise, 25 points.
   a. Men maintain plank position for 30 seconds, women for 20 seconds, 5 points
   b. Men maintain plank position for 60 seconds, women for 40 seconds, 10 points
   c. Men and women, 30 additional seconds plank with one arm off the ground 15 points.
   d. Men and women, 30 additional seconds of plank with one leg off the ground (both arms on the ground), 20 points.
   e. Men, 30 additional seconds, women 15 additional seconds with one arm and one leg off the ground, 25 points.
2. Chin up position for assessment of muscle and core strength. Max Score for this Exercise, 25 points
   a. Grab on to overhead bar and support your weight off the ground for 20 seconds, 5 points.
   b. Support your weight for 40 seconds, 10 points.
   c. All of the above plus 5 chin-ups for men and three for women, 20 points.
   d. All of the above plus 5 additional chin-ups for men and 3 additional for women WITH knee ups, 25 points.
3. Push-ups with balance requirements. Items required include a 25 or 29 inch exercise (yoga) yoga ball and a bosu, a product well known for balance and flexibility training.
   a. Hold push-up position with feet on ball for 15 seconds, 5 points.
   b. Hold push-up position with feet on ball for 30 seconds, 10 points.
   c. All the above plus 5 push-ups with feet on the ball, 15 points.
   d. All the above then maintain push-up position with feet on ball and hands on bosu 30 seconds for men and 15 seconds for women, 20 points.
   e. All the above plus 7 push-ups for men and 3 for women with feet on ball and hands on bosu, 25 points.
4. Wall Squats, a sitting position with back against the wall, feet flat on the ground and knees bent close to 90 degrees.
   a. Assume this position with back against the wall, feet flat on the ground for 30 seconds, 10 points.
   b. Maintain this position for one minute, 20 points.
   c. Maintain this position for two minutes, 25 points.
5. Flexibility testing max score 25 points.
   Forward bending in sitting position. Sit on the ground with your legs straight out in front of you, bend forward and reach toward your feet. If possible, grab onto your big toes and pull your upper body down towards the legs. If possible, bring the elbows down along either side of your legs, along the outside of the knees. Max score 15 points.
   a. hands below knees, 5 points
   b. hands to ankles 10 points
   c. hands to big toes, 12 points
   d. either head to legs below knees or elbows on the ground 15 points
Knee, ankle and foot stretch. Sit with your knees bent, bottom on the ground, knees fixed on the ground. Do not let your knees come off the ground. Do not proceed if your bottom cannot reach the ground. If so, begin to let your upper body go back, place one elbow on the ground then the other. Next, if possible, place shoulders on the ground, then back of head, final expression of the posture is to have arms folded resting behind head. Max score, 10 points
   a. Sit with knees bent, bottom on ground between the feet. Knees may be separated but must be on the ground, 5 points.
   b. Elbows on ground, 7 points.
   c. Head on the ground, 10 points.

### Total Score Rating for Pillars 1-6

Optimal health—Overall score of 850 or higher and at least 70% in each category
Good health—Overall score between 700-849
Fair health—Overall score between 600-699
Poor health—Overall score between 500-599

Having now fully described the invention, it will be apparent to one of ordinary skill in the art that many changes and modifications can be made thereto without departing from the spirit or scope of the invention as set for the herein.

Specifically, the testing of multiple wellness factors and the assignment of point scores to various wellness factors and wellness sub-factors is contemplated by the present invention to determine overall, comprehensive wellness state with a total point score. This testing is not limited to the wellness factors recited above but may include more than or less than the wellness factors listed above in Example 1. The testing must include at least two wellness factors. It is preferred that the wellness factors that make up the wellness index of the invention include the 6 wellness factors listed above. It is also preferred that the wellness factors include hormone, nutrition, oxygen and oxidative state, detoxification levels, mind/spirit test and body muscle flexibility, core strength and athletic improvement. Wellness scoring using multiple wellness factors to provide a total overall point score enables a person to determine how healthy or unhealthy they are and what areas need improvement. The improvement of one wellness factor will likely improve other wellness factors, as they are all interrelated.

Wellness scoring and total wellness scoring over a period of time using a wellness index with multiple wellness factors can determine improvement or deterioration of health and be useful to a physician for determining proper course of treatment.

The wellness index of the invention is a table showing each pillar and the maximum point score for a person in perfect health for each of the at least two pillars. It is used for comparison purposes and as a standard or goal for a patient to achieve via treatment.

In another embodiment a computer is used for measuring overall wellness compared to the wellness index. Information from testing the patient's wellness factors is entered into a computer program. Software is used to calculate the point score of the patient and compare it to the index. Software also tracks the patient's progress over time and stores the data.

With the use of a computer and software the method of the invention can be automated. In this embodiment, a computer-implemented method of measuring wellness and comparing a patient's wellness to a wellness index is employed. The steps of the method are as follows:
providing computer readable storage medium containing executable software code for performing the steps of:
providing questions relating to point scores for two or more wellness factors of a patient and requesting answers;
totaling said point scores;
comparing the total point score from the patients wellness factors to the wellness index maximum possible points; and
calculating wellness of the patient relative to a maximum possible points in the index;
suggesting treatment for improving said patient's total point score.

### REFERENCES

1. Vermeulen, A. (1996). Declining Androgens with Age: An Overview. In Vermeulen, A. & Oddens, & B. J. (Eds.), Androgens and the Aging Male (pp. 3-14). New York: Parthenon Publishing.

What is claimed is:

1. A method of measuring wellness in a person relative to an wellness index comprising:
creating a wellness index having maximum possible points assigned for at least two wellness factors;
measuring point scores for the same at least two wellness factors in a patient;
comparing the point scores from the patients wellness factors to the wellness index maximum possible points; and
determining wellness of the patient by examining how close the patient is to the maximum possible points in the index.

2. The method of claim 1, wherein said wellness factors are selected from the group consisting of hormone, nutrition, detoxification, oxygen state, mind/spirit, core strength, flexibility and athletic recovery.

3. The method of claim 1, further comprising the step of treating said patient to improve their point score relative to the wellness index.

4. The method of claim 1, further comprising the step of re-testing the patient at one or more later times to determine improvement or lack of improvement of said patient's point score relative to the wellness index.

5. The method of claim 1, where in said measuring comprises measuring each of hormone, nutrition, detoxification, oxygen state, mind/spirit, core strength, flexibility and athletic recovery.

6. A wellness index containing desired scores for multiple wellness factors, said wellness index for use in comparing the overall health of a person to said desired scores, said wellness factors comprising: hormone restoration, nutrition, detoxification, oxidative state, mind/spirit, core strength, flexibility and athletic recovery.

7. A method of measuring wellness in a population relative to a wellness index comprising:
creating a wellness index having maximum possible points assigned for at least two wellness factors;
measuring point scores for the at least two wellness factors in a population;
comparing the point scores from the population wellness factors to the wellness index maximum possible points; and
determining wellness of the population by examining how close the population is to the maximum possible points in the index.

8. Diagnosing and treating degenerative disease in a mammal comprising;
testing pH of tissues from said mammal;
treating said mammal with alkaline producing foods and/or oxygen therapy to raise pH in said tissue.

9. A computer-implemented method of calculating wellness and comparing a patient's wellness to a wellness index comprising:
providing computer readable storage medium containing executable software code for performing the steps of:
providing questions relating to point scores for two or more wellness factors of a patient and requesting point score answers for the wellness factors;
totaling said point scores;
comparing the total point score from the patients wellness factors to the wellness index maximum possible points; and
calculating wellness of the patient relative to a maximum possible points in the index;
suggesting treatment for improving said patient's total point score.

10. The computer-implemented method of claim 9, wherein said wellness factors are selected from the group consisting of hormone, nutrition, detoxification, oxygen state, mind/spirit, core strength, flexibility and athletic recovery.

11. The computer-implemented method of claim 9, wherein said wellness factors include each of hormone, nutrition, detoxification, oxygen state, mind/spirit, core strength, flexibility and athletic recovery
